(19) United States
(12) Patent Application Publication
(10) Pub. No.: US 2007/0250474 A1
(43) Pub. Date: Oct. 25, 2007

(54) System and method for implementing flash forward queries

(76) Inventors: Eric L. Barsness, Pine Island, MN (US); John M. Santosuosso, Rochester, MN (US)

Correspondence Address: IBM CORPORATION, 3605 HIGHWAY 52 NORTH, DEPT 917, ROCHESTER, MN, 55901-7829, US

(21) Appl. No.: 11/409,806

(22) Filed: Apr. 24, 2006

(51) Int. Cl. G06F 17/30

(52) U.S. Cl. 707/2

(57) ABSTRACT

A system, method, and computer-usable medium for implementing flash forward queries. According to a preferred embodiment of the present invention, a database predictive manager receives a specification of at least one database structure as a candidate for a flash forward query, which predicts a condition of the at least one database structure at a predetermined future time. Database predictive manager tracks changes made to the at least one database structure utilizing a history database. In response to receiving a flash forward query, database predictive manager presents results of the flash forward query, wherein the results are calculated based on extrapolating data obtained from the change tracking of the at least one database structure.

### BACKGROUND OF THE INVENTION

1. Technical Field

The present invention relates in general to the field of data processing systems. More particularly, the present invention relates to the field of data organization and processing within data processing systems. Still more particularly, the present invention relates to implementing flash forward queries within data processing systems.

2. Description of the Related Art

As well-known to those with skill in the art, most database systems have a “flashback” function that enables users to see a consistent view of a database as it was at some point in the past. However, there is a need for a system and method for users to make decisions based on the state the database may be in the future.

### SUMMARY OF THE INVENTION

The present invention includes a system, method, and computer-usable medium for implementing flash forward queries. According to a preferred embodiment of the present invention, a database predictive manager receives a specification of at least one database structure as a candidate for a flash forward query, which predicts a condition of the at least one database structure at a predetermined future time. Database predictive manager tracks changes made to the at least one database structure utilizing a history database. In response to receiving a flash forward query, database predictive manager presents results of the flash forward query, wherein the results are calculated based on extrapolating data obtained from the change tracking of the at least one database structure.

The above, as well as additional purposes, features, and advantages of the present invention will become apparent in the following detailed written description.

### BRIEF DESCRIPTION OF THE FIGURES

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1 is a block diagram illustrating an exemplary data processing system in which a preferred embodiment of the present invention may be implemented;

FIG. 2 depicts exemplary contents of the system memory of the data processing system illustrated in FIG. 1; and

FIG. 3 is a high-level logical flowchart diagram illustrating an exemplary method of implementing a flash forward query according to a preferred embodiment of the present invention.

### DETAILED DESCRIPTION OF AN ILLUSTRATIVE EMBODIMENT

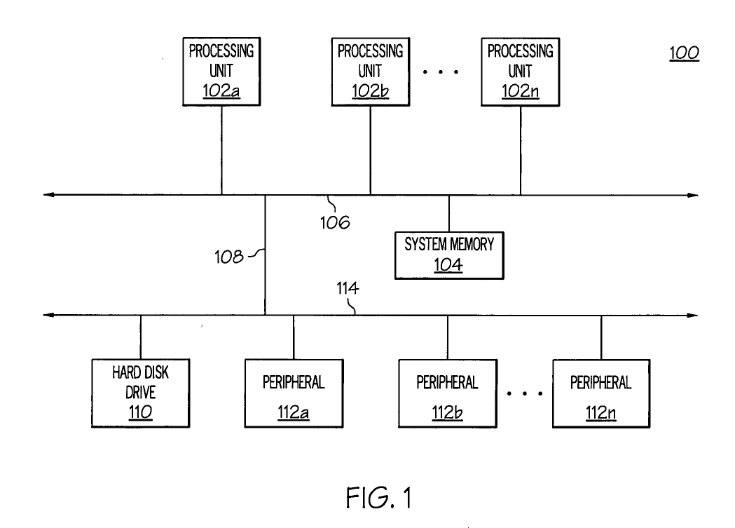

Referring now to the figures, and particularly, referring to FIG. 1, there is illustrated a block diagram depicting an exemplary data processing system 100 in which a preferred embodiment of the present invention may be implemented. As illustrated, exemplary data processing system 100 includes processing unit(s) 102a-n, which are coupled to system memory 104 via system bus 106. Preferably, system memory 104 may be implemented as a collection of dynamic random access memory (DRAM) modules. Typically, system memory 104 includes data and instructions for running a collection of applications. Mezzanine bus 108 acts as an intermediary between system bus 106 and peripheral bus 114. Those with skill in this art will appreciate that peripheral bus 114 may be implemented as a peripheral component interconnect (PCI), accelerated graphics port (AGP), or any other peripheral bus. Coupled to peripheral bus 114 is hard disk drive 110, which is utilized by data processing system 100 as a mass storage device. Also coupled to peripheral bus 114 is a collection of peripherals 112a-n.

Those skilled in the art will appreciate that data processing system 100 can include many additional components not specifically illustrated in FIG. 1. Because such additional components are not necessary for an understanding of the present invention, they are not illustrated in FIG. 1 or discussed further herein. It should also be understood, however, that the enhancements to data processing system 100 to implemented flash forward queries provided by the present invention are applicable to data processing systems of any system architecture and are in no way limited to the generalized multi-processor architecture or symmetric multi-processing (SMP) architecture illustrated in FIG. 1.

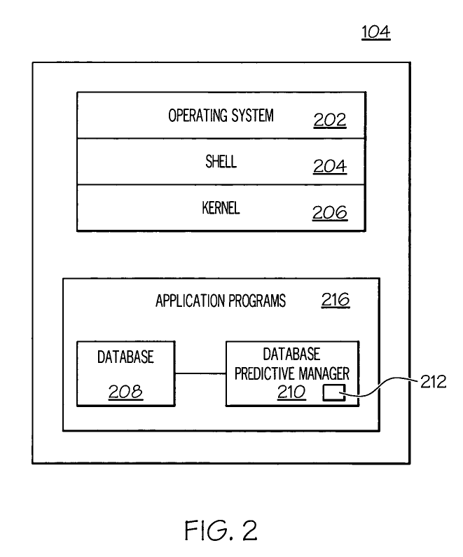

FIG. 2 is a block diagram illustrating exemplary contents of system memory 104 for data processing system 100 according to a preferred embodiment of the present invention. As illustrated, system memory 104 includes operating system 202, which further includes shell 204 for providing transparent user access to resources such as application programs 216. Generally, shell 204 is a program that provides an interpreter and an interface between the user and the operating system. More specifically, shell 204 executes commands that are entered into a command line user interface or a file. Thus, shell 204 (as it is called in UNIX®), also called a command processor in Windows®, is generally the highest level of the operating system software hierarchy and servers as a command interpreter. The shell provides a system prompt, interprets commands entered by keyboard, mouse, or other user input media, and sends the interpreted command(s) to the appropriate lower levels of the operating system (e.g., kernel 206) for processing. Note that while shell 204 is a text-based, line-oriented user interface, the present invention will support other user interface modes, such as graphical, voice, gestural, etc. equally well.

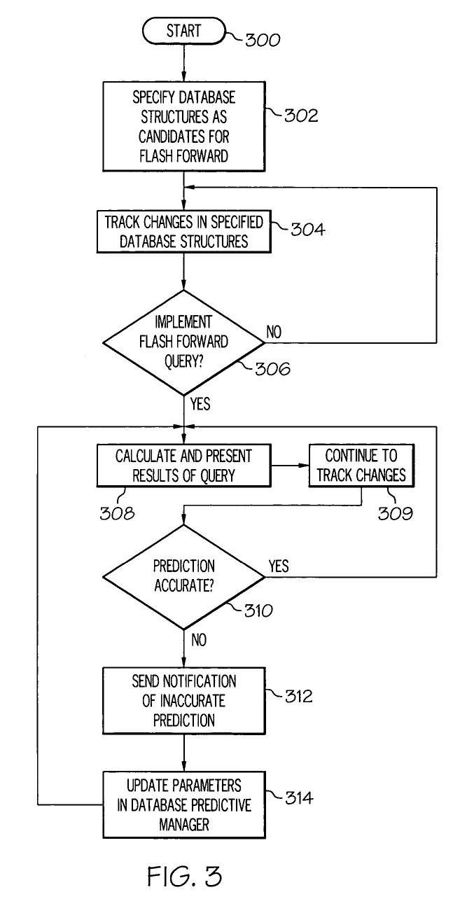

As illustrated, operating system 202 also includes kernel 206, which includes lower levels of functionality for operating system 202, including providing essential services required by other parts of operating system 202 and application programs 216, including memory management, process and task management, disk management, and mouse and keyboard management. Application programs 216 database 208, database predictive manager 210, history database 212 (all discussed herein in more detail in conjunction with FIG. 3), word processors, spreadsheets, and other application programs.

FIG. 3 is a high-level logical flowchart diagram illustrating an exemplary method of implementing a flash forward query according to a preferred embodiment of the present invention. The process begins at step 300 and proceeds to step 302, which illustrates a user utilizing database predictive manager 210 to access database 208 to specify database structures including, but not limited to individual files, fields in a file, specific database queries, a specific column, set of columns, or tables within a database, etc. Database predictive manager 210 creates entries into history database 212 that represent the specified database queries. Database predictive manager 210 also may optionally calculate a percentage likelihood of a prediction on a specific database structure to be correct in response to a flash forward query.

The process proceeds to step 304, which depicts database predictive manager 210 tracking changes in the specified database structures and recording the changes in the corresponding entries in history database 212. Later in the process, the entries in history database 212 are utilized to predict future values once a flash forward query is requested.

The process continues to step 306, which illustrates database predictive manager 210 determining if a flash forward query has been issued for the specified database structures in database 208. If a flash forward query has not been issued, the process returns to step 304 and proceeds in an iterative fashion. If a flash forward query has been issued, the process proceeds to steps 308-309, which depicts database predictive manager 210 displaying a prediction (extrapolated from the changes to the specified database structures recorded in history database 212), along with a percentage likelihood of the prediction being correct (as discussed earlier), in response to the flash forward query and continue to track changes made to the specified database structures and recording the changes in the corresponding entries in history database 212 (step 309). The process proceeds to step 310, which illustrates database predictive manager 210 determining if the prediction issued in response to the flash forward query is accurate. For example, if a flash forward query predicts a certain value to be reached in six months, and three months later, database 208 and database prediction manager 210 determines that the predicted value appears to be inaccurate, a notification will be sent to a system administration, as illustrated in step 312.

The process continues to step 314, which illustrates database prediction manager 210 recalculating the predicted value of the specified database structure. The process returns to step 308, and proceeds in an iterative fashion.

In another preferred embodiment of the present invention, if a report including the predicted value is generated ahead of time and database prediction manager 210 determines that the predicted value is inaccurate, the present invention can recalculate the predicted value and regenerate the report with a recalculated, more accurate value.

As discussed, the present invention includes a system, method, and computer-usable medium for implementing flash forward queries. According to a preferred embodiment of the present invention, a database predictive manager receives a specification of at least one database structure as a candidate for a flash forward query, which predicts a condition of the at least one database structure at a predetermined future time. Database predictive manager tracks changes made to the at least one database structure utilizing a history database. In response to receiving a flash forward query, database predictive manager presents results of the flash forward query, wherein the results are calculated based on extrapolating data obtained from the change tracking of the at least one database structure.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD-ROM, optical media), and communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

What is claimed is:

1. A computer-implementable method comprising:
specifying at least one database structure as a candidate for a flash forward query, wherein said flash forward query predicts a condition of said at least one database structure at a predetermined future time;
tracking changes made to said at least one database structure; and
in response to receiving a flash forward query, presenting results of said flash forward query, wherein said results are calculated based on extrapolating data obtained from said tracking changes.

2. The computer-implementable method according to claim 1, further comprising:
continuing to track changes made to said at least one database structure until reaching said predetermined future time; and
in response to determining said results are inaccurate, sending a notification of inaccurate prediction.

3. The computer-implementable method according to claim 1, wherein said presenting results further comprises:
calculating a percentage likelihood of said results being correct.

4. A system comprising:
a processor;
a data bus coupled to said processor; and
a computer-usable medium embodying computer program code, said computer-usable medium being coupled to said data bus, said computer program code comprising instructions executable by said processor and configured for:
specifying at least one database structure as a candidate for a flash forward query, wherein said flash forward query predicts a condition of said at least one database structure at a predetermined future time;
tracking changes made to said at least one database structure; and
in response to receiving a flash forward query, presenting results of said flash forward query, wherein said results are calculated based on extrapolating data obtained from said tracking changes.

5. The system according to claim 4, wherein said instructions are further configured for:
continuing to track changes made to said at least one database structure until reaching said predetermined future time; and
in response to determining said results are inaccurate, sending a notification of inaccurate prediction.

6. The system according to claim 4, wherein said instructions for presenting results are further configured for:
calculating a percentage likelihood of said results being correct.

7. A computer-usable medium embodying computer program code, said computer program code comprising computer-executable instructions configured for:
specifying at least one database structure as a candidate for a flash forward query, wherein said flash forward query predicts a condition of said at least one database structure at a predetermined future time;
tracking changes made to said at least one database structure; and
in response to receiving a flash forward query, presenting results of said flash forward query, wherein said results are calculated based on extrapolating data obtained from said tracking changes.

8. The computer-usable medium according to claim 7, wherein said embodied computer program code further comprises computer-executable instructions configured for:
continuing to track changes made to said at least one database structure until reaching said predetermined future time; and
in response to determining said results are inaccurate, sending a notification of inaccurate prediction.

9. The computer-usable medium according to claim 7, wherein said embodied computer program code comprising computer-executable instructions configured for said presenting results are further configured for:
calculating a percentage likelihood of said results being correct.
